(19) United States
(12) Patent Application Publication
(10) Pub. No.: US 2006/0164321 A1
(43) Pub. Date: Jul. 27, 2006

(54) Antenna and production method thereof

(76) Inventors: Christophe Mathieu, Poissy (FR); Sylvain Gossart, Mantes la Jolie (FR)

Correspondence Address: HARRINGTON & SMITH, LLP, 4 RESEARCH DRIVE, SHELTON, CT, 06484-6212, US

(21) Appl. No.: 10/540,278

(22) PCT Filed: Jan. 6, 2004
(86) PCT No.: PCT/FR04/50001

§ 371 Date: Jan. 23, 2006

(30) Foreign Application Priority Data
Jan. 24, 2003 (FR) 03 00942

(51) Int. Cl. H01Q 1/36

(52) U.S. Cl. 343/895

(57) ABSTRACT

In order to increase the efficiency of an RFID antenna, which has been printed and then metallized, the invention consists in producing an insulating strip including at least one first recess, which is intended to receive a track or an electrically conductive connection, whereby a slope is provided at the base of the recess and connects one face of the strip with another face thereof. The first recess facilitates conductive ink printing on the insulating strip. The invention also relates to a method of producing said antenna, such that the track is printed continuously on the dielectric support. When the conductive connection is disposed between the dielectric substrate and the insulating strip, the high electric resistance caused by the absence of metallization can be compensated for by increasing the width of the insulating strip.

The invention relates to an antenna and to a method of production thereof. The invention is intended, in particular, for the field of chip cards—for example, the field of wireless chip cards. However, the invention could also be applied in other fields, such as, for example, the field of radio frequency identification (or RFID) tags.

A wireless chip card comprises at least one antenna. An antenna may be connected to an electronic chip. The antenna forms a printed circuit or an electrically conductive track that consists of at least one spiral. A track may be formed by a series of spirals arranged one after the other. The electrically conducting track originates at a first contact pad and terminates at a second contact pad. Since the antenna and the electronic chip are intended to connect to each other and, since the electronic chip is of very small dimension in relation to the antenna, the connection of the antenna with the contact pad is made with an auxiliary contact pad and the second contact pad, said auxiliary contact pad being situated in the vicinity of the second contact pad. The auxiliary contact pad is connected to the first contact pad via a conductive connection or electrical connection, said connection having its origin at the first contact pad and said connection being intended to cross the electrically conductive track in order to be connected to the auxiliary contact pad. In order to insulate the conductive connection from the track, it is known to place an insulating strip between the track and the conductive connection.

A method of production of an antenna by serigraphy in order to produce such an antenna is known. The antenna is thus produced in three successive steps. The first step consists in producing by serigraphy the spirals of the antenna on a support made up of an insulating dielectric substrate. In this same step, a first contact pad, a second contact pad, and an auxiliary contact pad are also printed. The second step of the process consists in depositing by serigraphy a dielectric ink, which constitutes the insulating strip, above the spirals. Provided for in the third step is the connection of the first contact pad to the auxiliary contact pad by printing by serigraphy of a conductive connection passing above the insulating strip.

This method of production by serigraphy has the drawback of affording layers of relatively great thickness (10-15 μm). This method of production may thus have the drawback of affording a conductive connection that is susceptible to being made fragile by possible torsional or flexional forces, which could be produced at a site where the connection and the insulating strip are superimposed and in the vicinity of this same superimposition. In addition, the connection may be susceptible to becoming loose from the insulating strip as a result of these forces. A discontinuity in the electrical properties in the track or even a break in the electrical conductivity in the antenna may be produced. The output of the antenna may be strongly perturbed or may even be cancelled.

Another method of production of an antenna is known from the document FR 01 07115, D1. Described in D1 is a method of production of a planar antenna following the application of an electrically conductive ink onto the dielectric support by means of a helioengraving (gravure) process, followed by a metallization of the deposited ink in an electrolytic or chemical technique.

This method of production comprises the same steps as those mentioned above in the method of production by the serigraphic technique. This technique, which involves the technique of helioengraving, offers the advantage of printing ink layers of relatively finer thickness. However, as mentioned above, it is considered that the connection always tended to become fragile by possibly rubbing at a site where the connection and the insulating strip are superimposed and in the vicinity of this same insulating strip.

In order to increase the output of the antenna, while decreasing the discontinuity of the electrical properties in the track, the invention aims to facilitate the printing of the connection or of the track on the insulating strip by printing on the insulating strip at least one first recess, which is intended to receive the connection or the track. This first recess comprises, at the base of the recess, a slope that connects one face of the strip with another face of the strip. The insulating strip may also comprise at least one second recess, which comprises a slope that is oriented in the opposite direction in relation to the first recess.

The first recess and the second recess are produced in such a way that they enable the passage of the connection or of the track or of at least one conductive spiral. The first recess and/or the second recess permit facilitating the deposition of conductive ink on this same insulating strip.

The insulating strip can also be produced by one or more applications of dielectric ink. In the case where the insulating strip is produced by several applications of dielectric ink, the invention provides for producing the insulating strip in the form of a stepped pyramid along a longitudinal section of the antenna passing at the site of superimposition of the strip and of the connection. The form of the insulating strip as a stepped pyramid also permits facilitating the deposition of conductive ink on this same insulating strip.

The invention can be applied to printing techniques that require a metallization of the product that is thus printed, such as the helioengraving, offset, or serigraphy technique or the technique of electrostatic printing.

The object of the invention is thus an antenna comprising a dielectric support, an electrically conductive track printed on the support, said track originating at a first contact pad and terminating second contact pad, the first contact pad being connected to an auxiliary contact pad via a conductive connection, said auxiliary contact pad being situated in the vicinity of the second at a contact pad and said conductive connection being intended to cross the track, while being insulated from the track by a conductive strip interposed by superimposition between the track and the connection, characterized in that

the insulating strip is printed with at least one first recess, which is intended to receive the track or the connection, and comprises, at the base of the recess, a slope that connects one face of the strip with another face of the strip.

The invention also provides for a method of production of an antenna in which the track or the connection can be printed directly in one single step and in a continuous manner on the dielectric support, passing without interruption above the insulating strip.

The object of the invention is thus a method of production of an antenna, comprising a dielectric support, an electrically conductive track printed on the support, said track originating at a first contact pad and terminating at a second contact pad, the first contact pad being connected to an auxiliary contact pad via a conductive connection, said auxiliary contact pad being situated in the vicinity of the second contact pad and said conductive connection being intended to cross the track, while being insulated from the track by an insulating strip interposed by superimposition between the track and the connection, characterized in that it comprises the following steps, carried out in the following order:

the connection or the track is printed on the dielectric support,

then the insulating strip is printed on the connection or on the track,

then the track or the connection, respectively, is printed on the insulating strip.

The invention will be better understood by reading the description that follows and by examining the figures that accompany it. The latter are offered only by way of example and in no way limit the invention. The figures show the following:

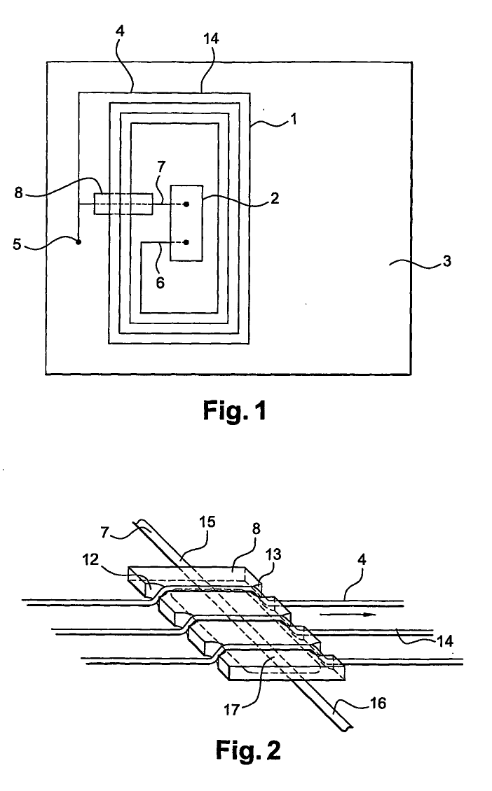

FIG. 1: a schematic depiction of an antenna in accordance with the invention;

FIG. 2: a depiction in perspective of an insulating strip in accordance with the invention;

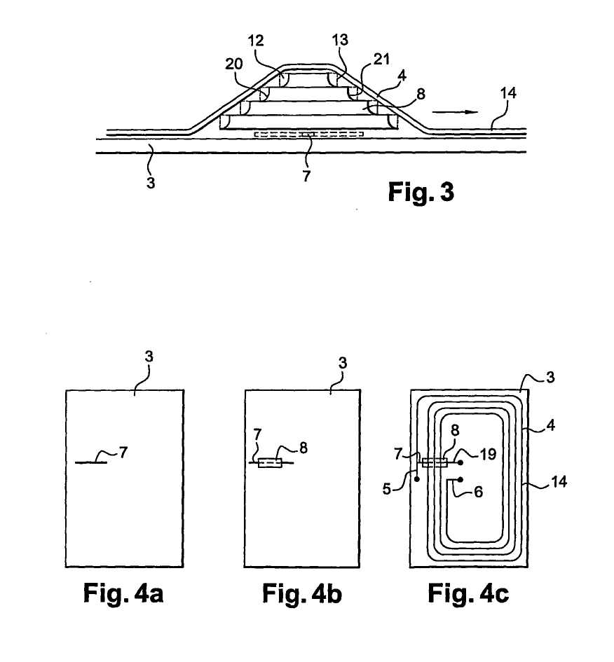

FIG. 3: a longitudinal section of an antenna along one direction of formation of a track in accordance with the invention;

FIGS. 4a to 4c: a schematic depiction of a method of production of an antenna in accordance with the invention;

FIG. 1 depicts an antenna 1. This antenna 1 may be intended for being connected to an electronic chip 2. This antenna 1 is printed on a dielectric support 3. This antenna forms a printed circuit or an electrically conductive track 4. This track 4 is formed by at least one spiral 14. In the example of FIG. 1, the antenna is formed by four spirals such as 14. The spirals 14 are connected to one another in series so as to form an electrically conductive track 4. This track 4 originates at a first contact pad 5 and terminates at a second contact pad 6. The first contact pad 5 is connected to an auxiliary contact pad 19 via a conductive connection 7, said auxiliary contact pad 19 being intended to be situated in the vicinity of the second contact pad 6 in such a manner as to facilitate an electrical connection of the antenna 1 with the chip 2.

The conductive connection 7 is intended to cross the track 4. In order to prevent a possible short circuit of the conductive connection 7 with the track 4, an insulating strip 8 is interposed by superimposition between the track and the connection 7. The insulating strip 8 thus prevents the conductive connection 7 from being in direct contact with the track 4.

In accordance with the invention, the insulating strip 8 is printed with at least one first recess 12, which is intended to receive the track or the connection and which comprises, at the base of the recess, a slope 20 that connects one face of the strip with another face of the strip (FIGS. 2 and 3). The first recess can be printed in the entire thickness of the insulating strip in such a manner as to form a strengthening piece or a reinforcement (FIG. 2). The insulating strip can also be printed with at least one second recess 13, said second recess 13 offering a slope 21 that is oriented in the opposite direction in relation to the slope 20 of the first recess 12 (FIG. 3). The first recess 12 can be produced at a first site of the insulating strip 8 that is intended to be first in contact with a spiral 14 or with the track 4. The second recess 13 can be produced at a second site of the insulating strip 8 that is intended to be last in contact with a spiral 14 or with the track 4. In one variant, the first recess 12 and the second recess 13 can be made at a site of the strip 8 that is intended to be first in contact with the connection 7 and to another site of the strip 8 that is intended to be last in contact with the connection.

In the example of FIG. 2, the insulating strip 8 is formed by three first recesses, such as 12, and by three second recesses, such as 13. The first recesses 12 and the second recesses 13 are produced in such a manner that they enable the passage of the track 4 or of at least one spiral 14. The first recess 12 and the second recess 13 can be advantageously produced so as to correspond to one another along one direction of formation of the track 4. The direction of formation of at least one spiral 14 or of the track 4 is depicted by an arrow in each of the FIGS. 2 and 3.

Preferably, the first recess 12 and/or the second recess 13 are intended to each receive a single spiral 14 in such a manner as to make more reliable the passage of each spiral.

The method of production of this antenna 1 on the dielectric support 3 can be carried out advantageously in the following manner (FIGS. 4a to 4c). In a first step, the conductive connection 7 is first printed on the dielectric support 3 with an electrically conductive ink (FIG. 4a). The conductive ink used can contain electrically conductive elements, such as copper, gold, or silver. The electrically conductive ink is that used at present, for example, in helioengraving techniques.

Next, in a second step, the insulating strip 8 is printed on the conductive connection 7 with a dielectricly insulating ink (FIG. 4b).

Next, in a third step, at least one spiral 14 is printed on the dielectric support 3 with an electrically conductive ink, passing continuously over the insulating strip 8. In the example of FIG. 4c, four spirals, such as 14, are produced, one after the other, so as to form a track 4. The four spirals are produced in such a manner that they are printed so as to pass over the insulating strip 8. The presence of at least one first recess 12 and/or of one second recess 13 permit facilitating the deposition of the conductive ink on the insulating strip 8. The track 4 is completed by printing the first contact pad 5 and the second contact pad 6 at a first end of the track 4 and at a second end of the same track 4, respectively, with an electrically conductive ink. The auxiliary contact pad 19 is also printed.

The method of production of this antenna 1 on the dielectric support 3 can also be carried out by printing first the track 4 and then the insulating strip 8 and finally, by printing continuously the connection 7 on the insulating strip 8.

The track 4 and the connection 7 can afterwards be metallized in such a manner as to decrease an electrical resistance of the antenna. The antenna can be metallized in an electrolytic technique or in a chemical technique.

The process of production of such an antenna is advantageously carried out by the technique of helioengraving. In fact, the technique of helioengraving makes it possible to obtain ink layers of very fine thickness of the order of 1 to 2 μm in thickness. However, the method of production of the antenna in accordance with the invention can also be carried out by other printing techniques. For example, the method of production of the antenna in accordance with the invention can be realized by printing techniques such as serigraphy, offset, flexography, or even by a technique of electrostatic printing.

The printing of the insulating strip 8 also can be carried out by a single application of dielectric ink. Or, the printing of the insulating strip 8 can be carried out by several applications of dielectric ink. Each of the applications of ink can afford a thickness of 1 to 2 μm (FIG. 3). When several applications of dielectric ink are carried out, it is possible to reinforce the insulation of the conductive connection in relation to the track via the intermediate position of the insulating strip. In a preferred embodiment, the dielectric ink can be applied in two or four applications. Each of the applications is carried out along one direction of formation of the track or along one direction of formation of the connection 7. The applications are carried out, one after the other, with a length of application that is smaller and smaller and in such a manner as to obtain a section in the form of a stepped pyramid of the insulating strip 8 along one direction of formation of the track 4 or along one direction of formation of the connection 7.

FIG. 3 illustrates an insulating strip 8 that is produced in four applications of dielectric ink so as to form a stepped pyramid along a longitudinal section of the antenna 1 at a site where the track 4 and the connection 7 are superimposed.

The conductive connection 7 comprises a first external portion 15, a second external portion 16, and a central portion 17. The first external portion 15 and the second external portion 16 are connected to each other by the central portion 17. The first external portion 15 is connected to the first contact pad 5 and the second external portion 16 is connected to the auxiliary contact pad 19. The central portion 17 of the conductive connection 7 corresponds to a portion of the conductive connection 7 that is situated between the dielectric support 3 and the insulating strip 8.

In the case where the connection 7 is printed first on the support, that is, in the case when the connection 7 is situated between the dielectric support 3 and the insulating strip 8, this central portion 17 is intended to be non-metallized. The antenna thus produced comprises a single portion of conductive connection situated at the contact with the insulating strip that will not be metallized. It is possible to compensate for the absence of metallization on this portion of the conductive connection by enlarging at least this central portion 17 of the conductive connection 7, as depicted in dashed lines in FIGS. 2 and 3. It could also be possible to enlarge the conductive connection 7 in its totality; that is, it could also be possible to enlarge the central portion 17, the first external portion 15, and the second external portion 16 of the conductive connection 7 (FIG. 2). The insulating strip 8 is then increased in size as a result in such a manner that the conductive connection 7 is not in contact with the track 4. By increasing the surface of the conductive connection, it is possible to compensate for the absence of metallization on this portion of the conductive connection. In this manner, all of the track can be metallized, while increasing the output of the antenna, by increasing the size of the conductive connection.

The dielectric support can be made of polyester or PVC or polypropylene, etc.

1. An antenna, comprising a dielectric support, an electrically conductive track printed on the support, said track originating at a first contact pad and terminating at a second contact pad, the first contact pad being connected to an auxiliary contact pad via a conductive connection, said auxiliary contact pad being situated in the vicinity of the second contact pad and said conductive connection being intended to cross the track, while being insulated from the track by an insulating strip interposed by superimposition between the track and the connection, characterized in that
the insulating strip is printed with at least one first recess intended to receive the track or the connection and comprising, in the base of the recess, a slope that connects one face of the strip with another face of the strip.

2. The antenna according to claim 1, further characterized in that it comprises at least one second recess furnished with a slope that is oriented in the opposite direction in relation to the slope of the first recess.

3. The antenna in accordance with claim 2, further characterized in that the first recess and the second recess are produced in such a manner that they enable the passage
of the track or of at lease one spiral, it being possible to form a track by a series of spirals that are in succession, one following the other, and/or
of the connection.

4. The antenna according to claim 2, further characterized in that the first recess and the second recess are produced so as to correspond to each other along one direction of formation of the track or of the connection.

5. The antenna according to claim 1, further characterized in that the insulating strip forms a stepped pyramid along a longitudinal section of the antenna passing at the site of the superimposition of the track and of the connection.

6. The antenna according to claim 1, further characterized in that the track and/or the connection is produced by a helioengraving technique.

7. The antenna according to claim 6, further characterized in that the track and/or the connection is afterwards metallized.

8. The antenna according to claim 1, further characterized in that the dielectric support is made of polyester or of PVC or of polypropylene.

9. A method of production of an antenna, comprising a dielectric support, an electrically conductive track printed on the support, said track originating at a first contact pad and terminating at a second contact pad, the first contact pad being connected to an auxiliary contact pad via a conductive connection, said auxiliary contact pad being situated in the vicinity of the second contact pad and said conductive connection being intended to cross the track, while being insulated from the track by an insulating strip interposed by superimposition between the track and the connection, characterized in that it comprises the following steps, carried out in the following order:
the connection or the track is printed on the dielectric support,
then the insulating strip is printed on the connection or on the track,
then the track or the connection, respectively, is printed on the insulating strip.

10. The method according to claim 9, further characterized in that
at least one portion of the connection printed on the support is enlarged, said portion being intended for being in contact with the support and with the insulating strip.

11. The method according to claim 9, further characterized in that
afterwards, the track or the connection is metallized in a chemical technique or in an electrolytic technique.

12. The method according to claim 9, further characterized in that
the track or the connection is printed by a helioengraving technique.

13. The method according to claim 9, further characterized in that
there is produced a least one first recess, intended to receive the track or the connection and comprising, in the base of the recess, a slope that connects one face of the strip with another face of the strip.

14. The method according to claim 13, characterized in that
at least one second recess is produced, comprising a slope that is oriented in the opposite direction in relation to the slope of the first recess, the first recess and the second recess corresponding to each other along one direction of formation or of the track of the connection.

15. The method according to claim 9, further characterized in that
the strip is produced by two applications or four applications of a dielectric ink in such a manner that the strip forms a stepped pyramid at the site of the superimposition of the track and of the connection.
